(19) United States
(12) Patent Application Publication
(10) Pub. No.: US 2008/0228578 A1
(43) Pub. Date: Sep. 18, 2008

(54) Digital rights management and data license management

(75) Inventor: Alex Mashinsky, Memphis, TN (US)

Correspondence Address: COHEN, PONTANI, LIEBERMAN & PAVANE LLP, 551 FIFTH AVENUE, SUITE 1210, NEW YORK, NY, 10176, US

(73) Assignee: Governing Dynamics, LLC, New York, NY (US)

(21) Appl. No.: 12/011,137

(22) Filed: Jan. 24, 2008

Related U.S. Application Data
(60) Provisional application No. 60/897,333, filed on Jan. 25, 2007.

(51) Int. Cl. G06F 15/173; G06F 17/30; G06Q 30/00

(52) U.S. Cl. 705/14; 709/224; 707/3; 707/E17.009

(57) ABSTRACT

A system and method for the exchanging, distributing and managing digital content, along with providing users with the ability to sell and transfer digital rights of products or services purchased from other users, wherein the system and method are used to manage synchronization and the use of applications, web services and media in combination with different digital rights management (DRM) solutions to authenticate and authorize such transactions.

### RELATED APPLICATIONS

This application claims priority from U.S. Provisional Patent Application Ser. No. 60/897,333 which was filed on Jan. 25, 2007.

### BACKGROUND OF THE INVENTION

1. Field of the Invention

The present invention generally relates to the field of digital rights management and, more particularly to a system and method for the exchanging, distributing and managing digital content, along with providing users with the ability to sell and transfer digital rights of products or services purchased from other users.

2. Description of the Related Art

With the increasing proliferation of digital media, the use of digital rights management (DRM) solutions to manage the use of the digital content has become increasingly necessary. Most conventional systems, devices or DRM solutions attempt to protect files or applications from unauthorized duplication (i.e., pirating) or use. However, the conventional solutions associated with such protections are easily defeated using conventional program decoding techniques.

In addition, such conventional systems attempt to restrict the use of purchased software or media to a single simultaneous use on a single device, thus, producing a less than desirable product due to restrictions associated with its use. Moreover, the conventional systems and methods permit a user to copy media for private use, with the proviso that the copied media will not be provided to third parties. However, there are difficulties associated with ensuring that unauthorized copies are not made and distributed to third parties, and there is no insurance against free broadcasts.

For example, when an artist produces a work of art, such as a musical composition, the work is recorded and digitized for distribution to a wide audience. In other instances, a large movie studio produces a movie or video or a similar audio video product. Digitizing such works for distribution, represents a major undertaking in ensuring that all relevant parties (i.e. the artists, producers, and individuals who acquire the intellectual property rights/the other intermediaries in the chain of distribution) are compensated for their work via complex licensing agreements. However, there is no insurance against free broadcasts and unauthorized distribution of copies of a work. Moreover, under current practices, the internet industry is not providing means for obtaining licenses for patents or trademark use by facilitating direct interaction between licensors and licensees.

### SUMMARY OF THE INVENTION

The present invention is a system and method for aggregating and linking intellectual property rights owners to distribution networks, internet based systems, and users. More specifically, the invention is directed to a system and method for finding, soliciting, aggregating, exchanging, distributing and managing digital content, while providing users with the ability to sell and transfer the rights they lawfully acquired to the digital products or services purchased from other users or distributors. At the same time, the invention provides a method of control over synchronization and the use of applications, web services and media, in combination with different digital rights management (DRM) solutions, by authenticating and authorizing such transactions to ensure a lawful transfer of the intellectual property rights.

Moreover, the invention not only brings together the parties such as individuals who hold rights to digital content, owners and distributors of digital content, as well as prospective users and buyers of same, but also it facilitates the interaction between the said parties and the interactive advertisement industry. The said interaction ensures that the original artists of the digital content are rewarded for their original works, and that the agreed terms for all these parties are enforced.

Users are permitted to transfer any type of media or application into multiple devices of their choice and synchronize the respective licenses with applications and data onto the said devices while being monitored via a central real-time exchange, which ensures that the users fulfill the DRM license agreement associated with their initial purchase. As a result, any device that has web connectivity can authenticate with the central real-time exchange to download or synchronize any application or data necessary, activate the DRM license on such data, and, if necessary, block all other devices from using the data. For instance, when one of the user's devices has connectivity to the central real-time exchange for playing or accessing a specific digital content, the remainder of that user's devices can be deactivated from playing or accessing the same digital content at that specific time. The contemplated system and method prevent fraudulent use of any application or data because the central real-time exchange of the system functions as a type of “on” and “off” switch for all licenses and the respective applications owned by the user of the devices.

The central real-time exchange provides “a public key,” which represents the permission of specific individuals to access the protected digital content, or another form of authorization to the user's device(s), and prevents all the other devices registered with it from using the same license elsewhere. Here, a user is allowed only a short connectivity period to transfer the DRM license, associated with a particular content, to another location. The user may transfer the DRM license: (a) to one or multiple devices, (b) from one device to the next, or (c) from one location to the next. In this manner the user will subsequently be permitted to operate such devices and their applications off-line. If, however, the user then attempts to activate a different device with the same DRM license, verification of the DRM license from the initial device is deactivated, and said activation must first be performed at the central real-time exchange. Typically, most new devices are provided with constant connectivity. As a result, activation and deactivation of the DRM license in accordance with an embodiment of the invention is incorporated into the login and activation and deactivation of such devices.

In certain embodiments, multiple device synchronization on an ongoing basis is permitted if all media and data are covered under the clearing facility DRM. As a result, a user can obtain the software for any application to which he owns the licenses at any time and just activate it for the specific use when he needs it. For example, in the event a user is traveling and does not have access to his own electronic devices, he will be permitted to download to someone else's electronic device, for a single use, specific software to which the user already owns a license and already obtained clearance from the central real-time exchange.

The system and method of the invention permits users to download or store digital content, such as music, audio/video games/files, movies, images, software, audio files and other data to multiple devices, and to access such digital content at any time without violating existing DRM restrictions. In addition, the system permits the purchase of licenses for patents, trademarks and copyright use.

Regarding license purchases, the current invention permits intellectual property holders to place on the market a desired package for licensing and it allows for licensees to find the said licensors to obtain patent licenses. Once a licensor registers to the site, the licensor presents his offer to license his patent. The licensor's offer comprises of his desired licensing package and specifies the royalty requirements. The licensor may opt either to deal with a licensee directly to negotiate the terms of the license, or may opt to use an intermediary to aid with the licensing process. In the event that negotiation is required, a licensee may either be referred to special links which facilitate the process of obtaining licenses by means of specialized agents or he may be referred directly to the licensor.

Regarding videos, a database of films and videos may be accessed through TV cable companies and permit users to see any movie they desire at any time for a small fee. This is a method which surpasses the efficiency and convenience factors of Blockbusters and Netflix. Both companies provide DVDs by mail to subscribers and once the DVD is returned and received, the subscriber may select and receive new DVDs. At this time, Blockbusters offers its subscribers the option of returning the DVD at any of its stores, which offers its subscribers an advantage over Netflix which only permits returns by mail. Hence, Blockbusters subscribers may renew their DVD supplies more quickly, rather than wait for mail delivery time. Under the current invention, a subscriber does not need to leave his home to either mail or personally deliver the DVD to the store. The subscriber may either downloads the movie/video on a device or have it distributed via his TV cable system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an exemplary schematic block diagram of the system in accordance with the invention;

FIG. 2 is a schematic block diagram illustrating the interaction of the central real-time exchange of the system of FIG. 1;

FIG. 3 is an exemplary schematic block diagram illustrating the interaction of the central real-time exchange of FIG. 2 with an advertising exchange;

FIG. 4 is a block diagram illustrating the interaction between different elements of the central real-time exchange in accordance with an embodiment of the present invention;

FIG. 5(a) is an exemplary schematic block diagram illustrating the processing of information collected by the central real-time exchange of FIG. 4;

FIG. 5(b) is a plan view of the different operating layers of the central real-time exchange in accordance with an embodiment of the invention;

FIG. 6 is a flow chart illustrating exemplary steps of the matching method in accordance with the contemplated embodiments of the invention;

FIG. 7 is a flow chart illustrating steps of the method in accordance with an aspect of the contemplated embodiments of the invention;

FIG. 8 is a flow chart illustrating a general overview of the steps of the method in accordance with an embodiment of the invention;

FIGS. 9(a) and 9(b) is a flow chart illustrating steps associated with the activities of a buyer up to the transmittal of content from the buyer to the central real-time exchange of FIG. 2;

FIG. 10 is a flow chart illustrating the steps associated with receiving, processing and matching content buyer orders and content seller offers at the central real-time exchange of FIG. 2; and

FIGS. 11(a) thru 11(e) is a flow chart illustrating the steps associated with the decision-making that is performed by the content buyer after the central real-time exchange has located at least one match between the order from the content buyer and at least one offer from the content seller.

### DETAILED DESCRIPTION OF THE PRESENTLY PREFERRED EMBODIMENTS

The present invention provides an efficient method for managing the distribution and usage of digital content. For the scope of this invention digital content comprises of patents, trademarks as well as copyright materials. The instant invention represents a virtual marketplace where intellectual property content fixed into digital format is presented to various users for the purpose of licensing, exchange, use, purchase, and sale.

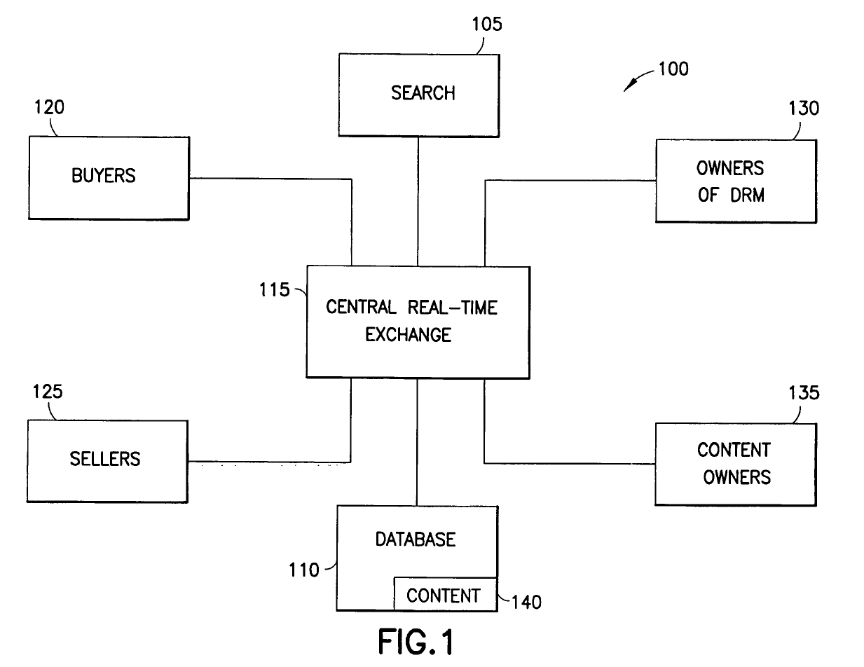

The present invention is directed to a system and method for exchanging, distributing and managing digital content, along with providing users with the ability to sell and/or transfer digital rights of products or services purchased from other users or other distributors. FIG. 1 is an exemplary schematic block diagram of the system 100 in accordance with the invention. The system 100 enables users to perform searches to identify and acquire digital content 105, such as games, movies, patents, trademarks, images, software and audio files, as well as licenses for patents, trademarks and copyright use. The respective digital content is uploaded to a database 110 via a central real-time exchange 115 from a multitude of providers and distributors. The system 100 tracks and retains information about digital rights management (DRM) and allows users (e.g., buyers 120, sellers 125 or distributors) to buy, sell or transfer such rights to other entities or individuals.

The system 100 includes a search engine 105 that is configured to correlate names of authors, directors, actors, games, movies, images, software and audio files, as well as ideas for patents, trademarks and copyright use to the owners of DRM 130 related to the digital content 105, as well as to individuals, corporate owners or distributors of such products, services or rights. In addition, the system 100 enables the buyers 120 to locate different sources of the digital content 105, including patent licensing and rights distribution, which they wish to find, and to determine the associated costs. In contemplated embodiments of the invention, upon locating the desired digital content 115, the system 100 offers to purchase, rent, sell, view, share or distribute the content 105 to a single or multiple users based on licensing and distribution rights agreements provided by the different owners of the content 135. The system 100 records the licensing requests of owners of the DRM 130 and the payment type at the central real-time exchange 115, as well as the amount that the owners of the DRM 130 wish to charge for their content. Furthermore, the system 100 keeps track of the user's ranking and licensing history as well as the revenue generated; hence allowing artists and DRM owners to sell future anticipated cash flow to others/investors. The system 100 then manages all requests for distribution and licensing from other buyers 120, as well as distribution partners and individual users.

After completion of a transaction, the system 100 coordinates payments and reconciliation of specific fees owed to a particular individual or entity in the value chain of the content 105 and DRM ownership via the central real-time exchange 115. In addition, prepaid and post paid services are supported by the system 100 of the contemplated embodiments of the invention, as well as sender paid and recipient paid setup of such services.

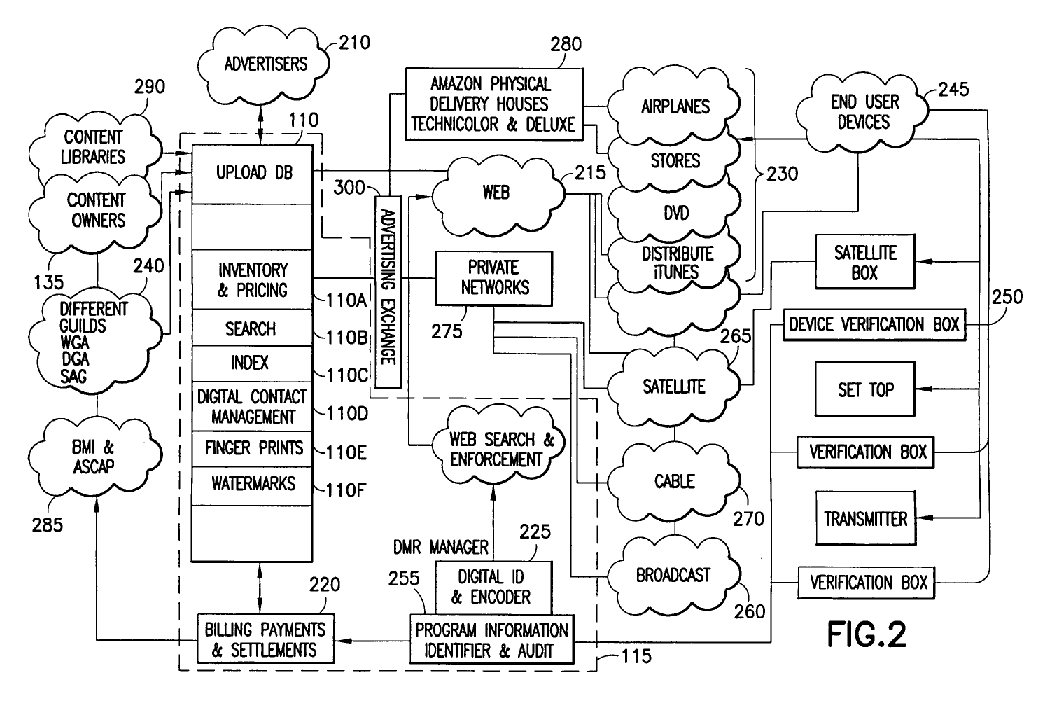

FIG. 2 is a schematic block diagram illustrating the interaction of the central real-time exchange 115 in the system of FIG. 1. With reference to FIG. 2, the central real-time exchange 115 supports multiple formats of licensing including open source, lifetime license, permanent non-transferable license, single use, as well as other formats. In accordance with the invention, content owners 135 may select to distribute content for free, where advertising provided from advertisers 210 would be attached (i.e., concatenated) to the media or located inside (i.e., encoded within) the media. In certain embodiments, the advertising is provided in a generic format so that every user can view the same advertisement. Alternatively, the advertising is provided in a customized format such that different users are provided with different bundles of content and advertising based on a profile of the distribution channel, the user, the network or geographic location. The matching of advertising to users may be performed at an internal database (not shown) or by collaboration with third party providers, such as Google™.

The central real-time exchange 115 may provide a revenue share to the owners of the DRM 130 (see FIG. 1) and other partners for all such revenues based on different formulas related to the specific arrangement of each transaction. For example, in the case where a person records a digital video clip, wishes to list the video clip on as many popular sites as possible and is also willing to distribute the video for free but wants to generate some level of advertising revenues, the user may list his digital video clip with the central real-time exchange 115. The exchange 115 will then submit the digital video clip bundled with specific ads via the Internet or web 215 to different search engines and other socially oriented web sites (not shown). In addition, the exchange 115 would manage the revenues generated from viewer fees, as well as click revenues generated by the digital video clip.

The central real-time exchange 115 includes a billing and settlement module 220 that stores contractual, billing, settlement, notification and reporting information. The central real-time exchange 115 performs all billing functions such as charging, collecting and crediting the appropriate parties against their transactions. The same user of the exchange 115 may be charged in one transaction and paid in the next, resulting in netting of all their charges and credits by the exchange. In contemplated embodiments, financial arrangements with different types of third parties may differ. As a result, the central real-time exchange 115 is required to calculate and then divide a revenue stream among these different parties. Here, the central real-time exchange 115 must also manage allocations and reconciliations, and then issue payments to all parties.

The system 100 of the invention supports multiple technologies, as well as different devices that provide different levels of security. As a result, the enforcement of DRM and encryption can be readily provided. Here, the central real-time exchange 115 of the system 100 manages which content is allowed to be downloaded or moved to which device. Download and movement control is managed via various known protection techniques provided by a multitude of third party entities. In accordance with the contemplated embodiments, content owners 135 are permitted to select the desired level of encryption and protection. The central real-time exchange 115 hosts and provides access to all supported mediums and devices, as well as authorized parties based on the level of encryption and protection selected by the content owner via the digital ID and encoder module 225.

When an exchange of content is performed between individual users, the central real-time exchange 115 manages the removal or transfer of content from one media source to another. For example, the central real-time exchange 115 may move a song, a software program or an image bought by one user of iTunes to an owner of a Microsoft or SanDisk player or to a cellular phone owned by a subscriber to a wireless network. Here, each user may select the source of the content and the format/licensing from an array of possibilities offered by the central real-time exchange 115 and transact with the central real-time exchange 115 for the purchase or exchange of the content.

With additional reference to FIG. 2, the central real-time exchange 115 is configured to permit third party fulfillment houses 280 of digital content, such as retail stores, iTunes music distributors or DVD suppliers, such as Netflix to sign up to perform delivery and distribution for the content owners on behalf of the exchange 115 to provide digital content to a single user or multiple purchasers of the content. Here, the exchange 115 may provide matching, referral services, and/or processing of a transaction download, financial settlement, enforcement of DRM rights and license management or the like, while content owners can select for which services they would like to contract.

The central real-time exchange 115 is also configured to permit software companies to outsource the management of software distribution and license management. In addition, the central real-time exchange 115 permits the sale of licenses from one owner to the next, as long as they have permission from the software publisher to do so. As a result, software companies are permitted to focus on their products, while allowing the central real-time exchange 115 to handle distribution, sale, collection and resale management associated with their digital content.

In another embodiment of the invention, the central real-time exchange 115 adds and combines digital content with other files or services by using its database or third party information that includes a request or a recommendation to perform such a combination. The combined information may then be forwarded to one or a large number of users who have subscribed to receive specific combined information. For example, a user may pay a subscription fee to obtain the top 5 jokes and audio/video files from top selected web sites. Here, individuals and corporations would list their content and describe their licensing requirements and permit the central real-time exchange 115 to monetize their creations or inventory. The exchange may collect ranking and popularity information from third parties and disseminate them.

In accordance with the contemplated embodiments, on one side, the system 100 manages the collection, flow, digitization, water marking and finger printing of content, as well as the digital documentation and certification of DRM licenses, contracts, and the payment distribution that flow from such financial arrangements. The system 100 of the invention also allows all contributors and participants in such digital content management to register at the exchange 115, agree to pre-negotiated licensing terms and conditions between the participants and or their guilds 240 to thereby receive financial payments once the system begins processing transactions associated with such digital content.

Database 110 includes modules for indicating inventory pricing 110a, searching 110b, title indexing 110c, digital contract management 110d, fingerprinting 110e and for watermarking 110f digital content that is uploaded to the database. By indexing the titles, participants and all third parties involved in the production of such digital content become bound to the content, which is then searchable via the system and external database and search engines or standard metadata search tools.

In accordance with the invention, the system 100 then manages the on-line and off-line worldwide distribution of the digital content as well as the licensing of intellectual property, such as patents and trademarks, for all types of networks and downloads, and enables special bundling of the content with other media or advertising that is provided by advertisers 210.

In order to provide a way to ensure enforcement of DRM of digital content, the system 100 utilizes a variety of methods to track and enforce DRM across the different systems and networks which broadcast or transport such content by means of verification equipment that is integrated into end user devices 245 to monitor all such systems and networks. Alternatively, the verification device is integrated into external boxes 250 placed on cable, satellite or broadcast networks that are serviced by private networks 275, such as Cablevision, Time Warner or Comcast™. The verification equipment is used to monitor the specific content that is broadcast, when and by whom, and reconciles such usage with the contractual agreements that are located in the central real-time exchange 115 of the system. In accordance with the contemplated embodiments, the verification devices 250 may use a variety of methods to recognize the content that is being broadcasted or distributed. The program information identifier and audit module 255 of the central real-time exchange 115 is used to insert and compare tags and codes, as for example, watermarks, special tags or ID's, scanning of files, audio sampling or character recognition. Such tags and codes are inserted and compared with the corresponding information for the digital content that is located in the database 110 to verify what source and under which DRM license such content is being provided. The system may use DRM owner codes, or security or system 100 provided security.

The system and method of the invention provides the originators of digital content with a way to more closely control their digital content and how it is being used. In addition, a way to rapidly collect and distribute royalty payments to the appropriate parties is provided by the system and method of the invention. At present, all payment and royalty contracts, as well as collections, are performed manually. As a result, payments are sometimes received after a long delay, such as 1 year. The system and method of the invention eliminates this delay by allowing for an improved, faster collection and distribution of payments to existing and new distribution “channels”, which were previously unavailable due to the inability of the content owners to control their rights associated with the digital content. Since distribution networks sign up to such terms upfront, the payment terms are agreed to upfront as well.

The system and method of the invention creates an environment in which micro-payments and low value transactions may occur at a profit. Previously, such transactions were uneconomical because the process of negotiating and collecting fee for such small value transactions failed to justify the considerable manpower expenditure associated with such locating, contracting and collecting payments. The Internet is an environment that has low associated overhead, i.e., transaction costs are nominal. For example, an individual is permitted to order a program for one dollar and all parties involved can make a profit servicing such a customer.

In accordance with the contemplated embodiments, the system 100 nets out payments that may belong to different networks against the royalties they owe to the content owners 135. As a result, fast and efficient settlements of outstanding balances are provided. In addition, payments associated with the distribution of the digital content occur almost immediately. For example the system 100 may net the advertising revenues due to a broadcast network 260, satellite provider 265 or cable provider 270 from the digital content purchased and broadcasted to a user over the private networks 275.

The system 100 is configured to match and arrange the matching of the digital content with the advertisers 210, broadcasters 260 or the networks providers 275. As a result, the system 100 can also perform real-time management with respect to the specific fee that is owed, based on the actual transactions that occurred. In accordance with the contemplated embodiments of the invention, all parties enroll with the system 100 and provide availability and a profile of their networks and capabilities as well as the terms under which they would like to participate. In addition, the parties may suggest matches based on rating agencies, statistical or competitor information. Based on the input of the parties, proposed matches are presented to all parties for their acceptance. Such matches may be originated by the exchange or by any of the participants. Upon acceptance of the terms and conditions, an electronic signature is entered to signify agreement and activate the ability of a download or digital stream of a scheduled broadcast or sale of the digital content.

Moreover, the system 100 supports all different types of digital encryptions and encodings for online and physical distribution. Upon completion of a transaction between all related parties and an upload of a digital master, such content may be sent to an on-line or off-line production house, which may duplicate, replicate or redistribute such content as per the license agreement. The exchange may offer such services from multiple players and allow the content owners to contract on such terms as part of the initial transaction.

The system 100 also contemplates allowing the user to view, download, store or transfer the digital content among different devices he owns or has access to and manage the DRM related to such use. In addition, exchange users are permitted to buy, sell or trade the licensing rights to digital content, as well as then sell or offer the content from a distributor or retailer 280 via the web or an off-line shipper.

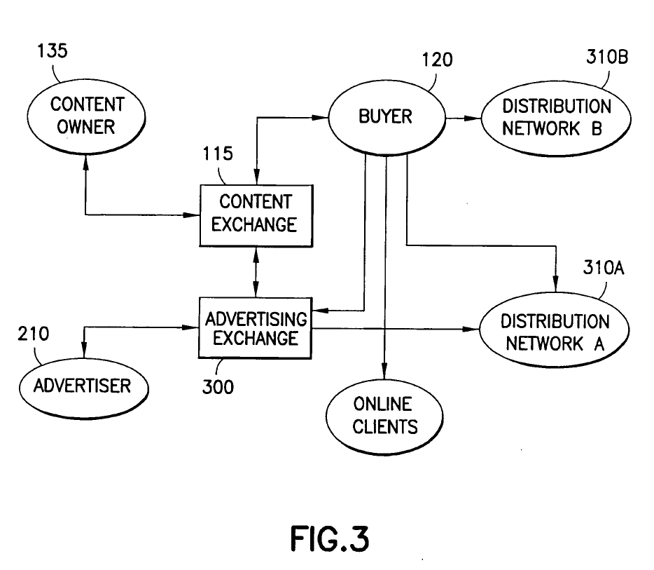

FIG. 3 is an exemplary schematic block diagram illustrating the interaction of the central real-time exchange with the advertising exchange of FIG. 2.

The central real-time exchange 115 manages the system 100 so as to control what type of content and pricing is being offered to advertisers 210 while also matching the content to restrictions that buyers, content owners or advertisers may institute. Here, segmenting the advertising mediums and markets by category permits market-by-market content placement and budget management.

Many ad agencies serve the function of selecting, contracting and paying for media bought from many sources. Such agencies serve to aggregate many clients and have a single interface and payment source for the seller of the ad space. The central real-time exchange 115 and advertising exchange 300 of the present invention operate such that the requirement for an ad agency is eliminated. The central real-time exchange 115 and advertising exchange 300 also eliminate the need to work with networks, such as DoubleClick or Google™, by finding and matching advertisers 210 and owners of content and DRM licenses and eliminating any middlemen. That is, the central real-time exchange 115 serves the same function as licensing entities, guilds 240 and representatives of artists 285 (see FIG. 2), such as ASCAP or BMI and the advertising exchange 300 serves the same function as an ad agency, each at lower fees. However, the central real-time exchange 115 aggregates a greater number of content buyers 120 and content owners 135 and provides centralized settlement and tracking discovery of effectiveness on behalf of many more content buyers and owners. In addition, the central real-time exchange 115 ensures that funds are collected, provides for dispute resolution, as well as historical data on spending trends and pricing data. Data about the market can be collected, sorted and sold to third parties. In one embodiment, the central real-time exchange guarantees payments and eliminates bad debt for content sellers.

In another embodiment, the central real-time exchange 115 operates to improve the cash flow of content owner 135 by allowing them to offer pre-payment for a discount or sell DRM licenses in advance for an extended period of time, as well as allow content buyers 120 to assume the risk associated with fluctuating prices and cash flow for such content. As a result, a secondary market is provided in which trading for such content occurs, either in the same or a separate marketplace. Licenses can be aggregated, packaged, and securitized on financial markets to provide liquidity and monetization of licenses for content owners 135. In an embodiment, advertisement space buyers 210 are permitted to decide whether to enter long and/or short-term commitments for advertising space that is bundled with digital content with greater ease, and then easily sell those “ad spots” in the secondary market if budgetary or advertising needs change. In such a market, the prime DRM license holders will be able to obtain a better value for their licenses by allowing content buyers 120 to eliminate the risk associated with a purchase decision.

In another contemplated embodiment, the advertising exchange 300 collects buy orders from traditional on-line and media buyers, and obtains different types of advertising space inventory from on-line and traditional media sellers. Here, each selling party is permitted to register in an on-line site, describe the nature and demographics of their media and the price they are charging for different advertising slots, or provide such data from a reputable third party.

In addition, content owner 135 are permitted to restrict certain content from being bundled with certain digital content due to competitive issues, legal issues or censorship issues. Here, for example, each buying party may register on the same site and specify key words, products, geography, budget and type of campaign being sought for the duration of the campaign, the markets to be covered and the demographics of the people buyers are trying to reach within a certain budget. The central real-time exchange 115 then processes such requests and displays the best matches to the content buyer 120 based on current prices and orders with advertisement spaces offered by content owners 135 based on historical and real-time conversion results which were provided to the central real-time exchange. Such a match may be based on a buyer's need, having designated the lowest price per viewer. Alternatively, the match may be based on the highest conversion rate for each dollar spent on a specific day.

In accordance with the contemplated embodiments of the present invention, sellers with “virtual inventory” can emerge. For example, a seller with virtual DRM licenses would trade in future capacity much in a manner that traders trade stocks or bonds. Here, a trader would buy long-term licensing contracts and sell them as short term multiple contracts or package them with other types of content and securitize the contracts or the cash flow associated with the license contracts. Content sellers may package many such contracts and sell them as a security or bond to other content buyers, with the central real-time exchange 115 serving as the marketplace to price, trade and settle such transactions.

It is possible for a specific content owner 135 to be unable to fill all of the content buyer's budget or conversion needs or parameters, either by virtue of content availability, click through price, or the like. As a result, the central real-time exchange 115 is configured to provide an alternate match in real-time to the next owner's available type of content, and so on until the budget on the buy order has been fulfilled. The match is then sent to a content buyer 120 who is then permitted to view the proposed distribution of his budget over the content in real-time and can decide to continue to purchase, buy an option for future use or simply reserve the capacity to do so under certain terms or conditions. Alternatively, the content buyer may place limit orders that will automatically execute his purchase orders through the budget allocation manager.

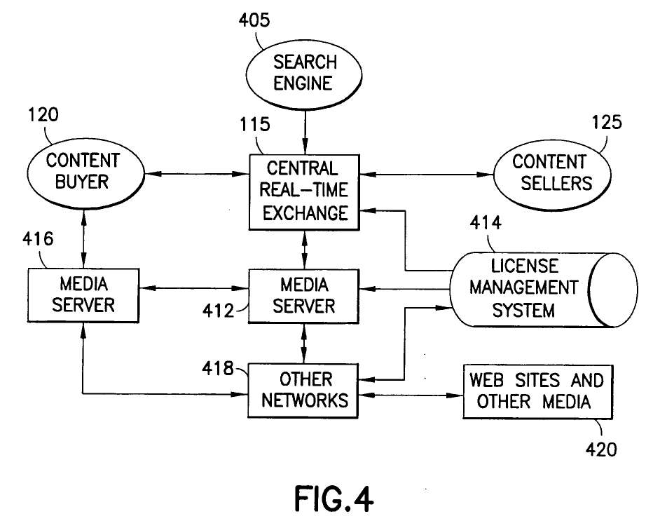

When purchase orders are placed or executed, the central real-time exchange 115 may instruct the advertising exchange 300 to deliver the appropriate ad from the buyer's media server 416 (see FIG. 4) or the advertising exchange 300 to distribution network 310a, 310b for presentation to the next viewer for advertising. Such ads may be resident on the content owner's media server 416 to minimize latency. For instance, the distribution network 310a, 310b may guarantee that a certain show's ratings or web limits will not be below a certain level. The central real-time exchange 115 then “books” the transaction and prepares to transfer some or all of the funds between the content buyer and the single or multiple content owners with which the content buyer previously entered into a purchase contract with. The central real-time exchange 115 bundles the advertisements with the different digital content so as to permit the advertisements to be aired in accordance with an agreed upon purchase plan. The central real-time exchange 115 then measures in real-time the performance of the distribution network 310a, 310b, and if the performance of the network falls below predetermined expectation levels, then the central real-time exchange may replace the under performing ads in real-time with other ads that require lower conversions at a lower price. Unlike the systems used by Google™ or Yahoo!™, the central real-time exchange of the system of the contemplated embodiments does not display a price per click or per order. Rather, the central real-time exchange permits content buyers and content sellers to show their buy and sell orders so matches can be made directly with full disclosure of terms and historical performance. In addition, the central real-time exchange does not keep the spread between buy and sell orders in the same manner as the Google™ system. Rather, a full price discovery is provided to the content buyers, after which transaction and settlement fees are charged.

In accordance with the contemplated embodiments, measurements are performed to collect information from multiple sources to compile accurate conversion and exposure information about content buyers 120. The multiple sources may include third party rating agencies, pricing and buyers supply chain software, website tracking software, third party inventory, conversion and trading orders, increase in web visits or call center calls over historical levels, conversion results for all buyers in the same industry across many buyers categorized by media types, dates and geography and other information relevant to buyers making a buying decision and sellers making inventory decisions.

Data from the supply chain and customer relations management (CRM) systems of a buyer can be linked to the central real-time exchange 115 such that real-time feedback of actual orders can be correlated to the media buys. As a result, the content buyer's budget with the central real-time exchange is optimized. In this case, the data can be provided periodically or it can be integrated via web services to the central real-time exchange for real-time optimization. In addition, the method in accordance with the contemplated embodiments permits content owners 135 to provide different tracking agencies with their respective data to demonstrate improved ranking or performance. Here, results from sales outlets are provided and fed to databases to compare the promised level of performance to the actual level that is that achieved over the distribution network by the ad media “bundled” with the digital content. If the performance of the distribution network is below the expected level, the central real-time exchange 115 may issue an additional charge against the distribution network.

On the other hand, if the results of the distribution network 310a or 310b exceed the expected level, the central real-time exchange 115 may charge the buyer a premium, based on a contractual agreement between the parties executed at the time of sale. In accordance with the contemplated embodiments, data is collected for all types of ads. As a result, any advertiser can view projected conversion rates and the efficiency of spending his budget dollars on a specific medium on a specific day. Here, the central real-time exchange 115 then displays the real-time transacted data segmented by industry, category, product, service, conversion, and other categories as they correlate to digital content associated with specific media types and license profiles from different owners of content on the web to permit other content buyers 120 and content owners 135 to adjust their pricing and buying needs, as well as the price that is paid for each digital medium, ad or page on a web site.

In accordance with the contemplated embodiments, the central real-time exchange 115 permits different types of content owners and sellers to compete on price/performance against each other in a single market space, on each category and spot where the results of the dollars spent can be immediately tracked and converted into additional buys or redirected to other forms of advertising. Here, the central real-time exchange 115 maintains a detailed database (not shown) that includes the prices of all forms of ads for all types of advertising channels, voice and data networks and for all types of digital content for different media, while keeping the identity of potential content buyers 120 and their specific prices and profile needs anonymous, if desired. In addition, the central real-time exchange 115 displays the last price paid for such digital content, arranged by different product categories. Moreover, the central real-time exchange 115 shows all buy and sell orders to users for each ad or each buy order and shows matched orders and their prices.

The method of the contemplated embodiments seeks to more accurately match different content buyers 120 to the ad space that provides buyers with optimal sales results. As a result, the central real-time exchange 115 is configured to provide the optimal match that will minimize buyer spending, while at the same time maximize the revenues generated by content sellers. Here, it is market price dynamics that dictate whether prices for ads, webs and blogs fluctuate, which will set the specific price for a specific day for the word car within digital content on a specific search engine or web site registered with the central real-time exchange. In addition, the central real-time exchange is also configured to provide customized direct marketing, which is implemented via different media applications. As a result, content buyers 120 and content sellers 125 are permitted to focus their advertising expenditures on specific venues in proven segments that have potential customers and accurately track the response and conversion rates of these expenditures.

In general, sellers of ad space compete among themselves and media types, such as the Internet, TV, radio or outdoor billboards. Conversely, buyers compete among each other in the same category and with other different product categories that may prove more effective at certain times on certain types of ad media. All such information is published or purchased by buyers and sellers so they can optimize their trading and generate better conversions or monetization of licenses. Such optimization can be achieved manually or by submitting all such information to a dashboard and budget allocation manager by including their own internal market data, as well as third party performance data for other network buyers and sellers guaranteed optimization. As a result, buyers may agree to pay more for a specific content type on a specific day, set time of day, etc. Initially, the central real-time exchange 115 matches and transacts on such data. In addition, the central real-time exchange 115 is configured to broadcast or stream ads in digital content in any format to and via any desired network to third parties on pre-agreed contractual terms.

On the web, the placement of ads is managed by large network companies, such as Google™, Yahoo!™ or Microsoft, which are adverse to the interests of advertisers or spread between buyers and sellers. These companies are driven by the sole objective of optimizing their respective profits and operate as black boxes and actually shield market information from all parties so as to optimize their profit margins. Unlike Google™ or Yahoo!™, the contemplated central real-time exchange 115 and the advertising exchange 300 do not function as a black box against which advertisers 210 bid on one side and on the other side, content owners 135 bid against each other. Rather, the central real-time exchange 115 and the advertising exchange 300 function as a facilitator that permit market and ratings data to dictate in real-time price and availability of media segments within digital content, banner space or keywords and their relevant pricing on a certain day and for a certain media type or certain day and time.

In accordance with the contemplated embodiments, the system and method of the present invention capitalizes on new technologies associated with providing a solution to creating a flexible, dynamic, fluid real-time marketplace for licensing, advertising and DRM management. The system provides sellers with direct access to customers. In addition, the central real-time exchange 115 permits the maximization of license value and eliminates time or geographical constraints associated with ads or exposure coverage. The present method and system of the contemplated embodiments permits a seller to enter geographic markets that may possess different conversion prices or costs merge each country or region. In addition, the method and system expands the number of ad choices available to content buyers. As a result, the choices and selection for purchasing opportunities is maximized.

Furthermore, content buyers 120 are provided with real-time access to market prices and media availability in each geographic market covered by the advertising exchange 300. Here, the central real-time exchange 115 reduces transaction costs for both content buyers 120 and content owners 135 and increases the overall dollars spent by allowing smaller companies and new types of products to advertise and use mediums that were previously unaffordable or were previously not cost effective. The system and method provides for centralized and automated advertisement orders, order confirming, invoicing, reporting and billing for any content buyer or content owner. As a result, content buyers and owners are permitted to enter into commerce with a large number of entities with relative ease, as well as without being exposed to the risks associated with bad receivables.

It is to be understood that the system and method of the contemplated embodiments may be implemented in various forms of hardware, software, firmware, special purpose processors, or a combination thereof. In the preferred embodiment, the invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present principles.

FIG. 4 is a schematic block diagram illustrating the interaction between content sellers and content buyers with the central real-time exchange 115 in accordance with an embodiment of the present invention. In particular, FIG. 4 illustrates the interaction between the content sellers and content buyers associated with the dynamic addition of content libraries 290 to the database 110 of FIG. 2, where the newly added content that is sent to subscribers of the central real-time exchange, and where messages are linked or encapsulated with ads from the exchange and delivered via the media servers 412, 416. In accordance with the contemplated embodiments, central real-time exchange 115 receives newly added digital content and correlates that newly added information with the content buyers 120 and content sellers 125 requests via other programs. The content buyers 120 are connected to a media buyer server 416 which, in turn, is connected to the other media server 418.

The sellers of new digital content have their own license management system 414 that is in communication with a media server 412, the central real-time exchange 115 and other networks 418 that include any non-Internet based network, and may also include networks, such as Google™, Yahoo!™ or the like. In addition, the license management system 414 is connected to other websites/other media 420 which can include TV, radio, etc.

The media server 416 maintains storage of the content buyer's content purchases and purchase orders route plan, and also receives feedback information from the central real-time exchange 115 to provide the content buyer with real-time conversion information relating to their digital content purchases. Content sellers 135 have an inventory of licenses that are managed with the license management system 414 that is connected directly to the central real-time exchange 115, the other media server 412, the other networks 418 and webs sites and other media 420. The license management system 414 allows the content sellers 125 to monitor available content they are selling in the various different content categories in substantially real-time and direct their licenses to the network or system providing best monetization of their licenses.

As shown, the content sellers 125 and the content buyers 120 can be connected directly to the central real-time exchange 115 to enable content sellers and content buyers to bypass the automated aspects of the contemplated embodiments of the system and work directly with each other.

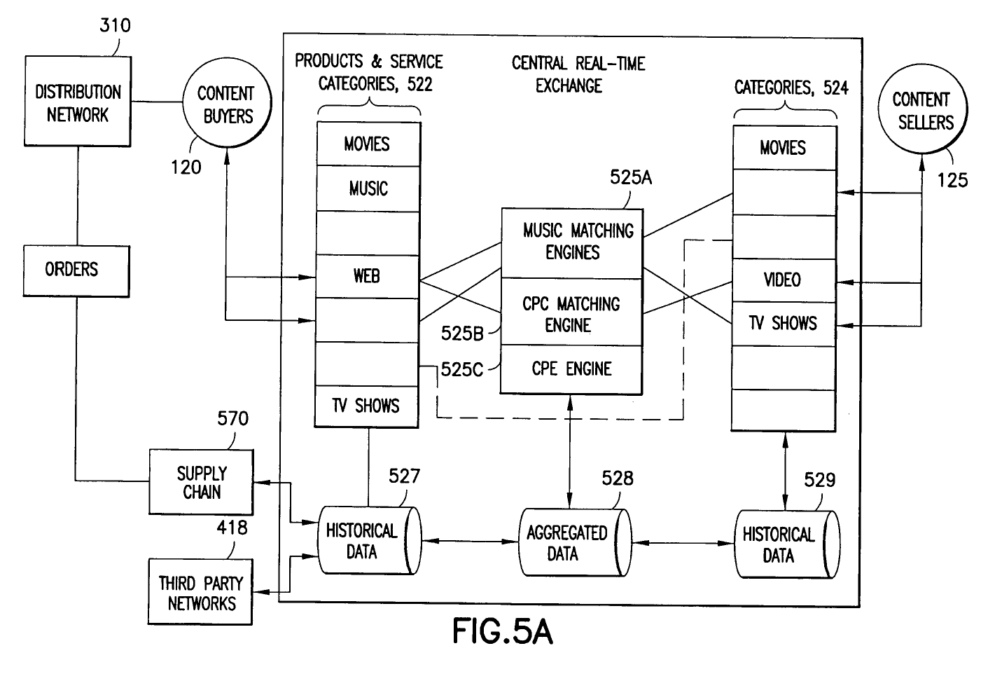

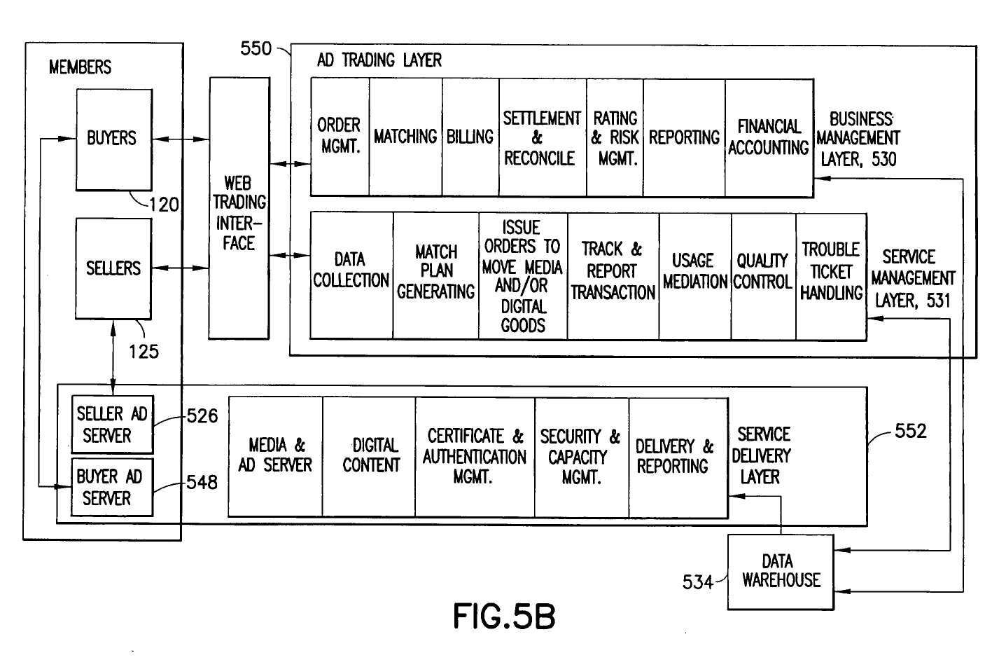

FIG. 5(a) is a block diagram of the central real-time exchange 115 in accordance with an embodiment of the invention. In particular, FIG. 5(a) is a block diagram of a comparison that occurs between content buyers and content sellers for a specific item of digital content or related group of content on which a match in price and content was established.

In accordance with the present embodiment, the central real-time exchange 115 has various matching engines 525, such as a music matching engine 525a, a movie matching engine 525b and an image matching engine 525c. These matching engines are web based and are shown for exemplary purposes. For example, the matching engine 525 can be configured to match the sale and purchase of digital content on any digital network in accordance with the disclosed embodiments.

In certain embodiments, the central real-time exchange 115 operates to collect and match content trades, execute the trades and deliver the content, while also settling the trades and collecting related market data. The data collected by the central real-time exchange 115 can come from its own activities based on subscribed content buyers and content sellers, from third party networks 418 and/or any other source of marketing data that it can be connected to.

By way of example, and referring to FIG. 5(a), a content seller 125 lists the categories 524 for which they want to compete or have content available. For example, the content seller 125 has media space on the web and on the radio related to specific music titles. Content buyer 120 enters a request into the system to locate digital content within a specific genre of music. As a result, the central real-time exchange 115 compares the content buyer's request with the licenses of content for each and every content seller 125 that is part of (or subscribes to) the system of the invention. Here, the content buyer 120 will be presented with the music or movies available from at least this particular seller. By collecting relevant information from the historical databases 527, 528 and 529, the content buyer 120 will be shown music, movies or image information related to the success and pricing levels available in the marketplace for their selected category or specific products or services which they may select 524. Buyers can then proceed to select and link to specific sellers or products or let the system manage such links for them automatically. In addition, the central real-time exchange 115 will also match this buyer with this seller for the requested music title.

The central real-time exchange 115 includes content buyer historical data 527 and content seller historical data 529. The buyer historical data 527 obtains information directly from the buyer upon each transaction that occurred, while at the same time compiling relevant information from a supply chain 570 and other third party networks 418. The historical data can provide the content buyer with a view of all the alternatives available to him, including ones that are not available in the marketplace. The content buyer and content seller historical data 527 and 529 are aggregated 528 within the central real-time exchange so as to provide the exchange with as much information possible when processing matches for content buyer orders and content seller digital content, and allow the central real-time exchange to perform optimization of all options including internal inventory and third party networks. Such data is also used by others to change pricing and category information so as to better compete with other sellers and buyers in the marketplace. By changing buyer minimum requirements and seller minimum pricing, better matches and higher revenues are generated.

According to one aspect of the invention, the central real-time exchange 115 may also utilize artificial intelligence (AI), user feedback, Digital Objects Identifier (DOI) links, web services, xhtml tags or other tools to enhance the ability to match the flow of digital content to the queries in the system, as well as to “self train” the system to permit content buyers 120 to prioritize and focus their queries to relevant information aggregated by central real-time exchange 115. In general, comparison engines or other automated systems may contain millions of queries that access central real-time exchange 115 at any given time and during use. Such users or engines may generate a substantial revenue stream if their conversion ratios for digital content provide enhanced matching services to their customers.

The central real-time exchange 115 of the present contemplated embodiments provides an alternative to the traditional methods of distributing digital content to the public, such as via peer-to-peer networks, iTunes or direct downloads from web sites. Typically, such digital content is submitted with the hope that people who want to receive the particular content will actually receive or locate it. In the contemplated embodiments, conventional systems are replaced by a system that provides owners of content and content sellers a good reason to upload their content to the central real-time exchange, since games, movies, images, audio files, patents, trademarks, software or service releases can be directed to only interested parties. If digital content that matches the interests of subscribers to the exchange is found, a function that is approved by the subscriber is performed. For example, the function may be providing a daily “radio station” or TV station, which has the type of content the user likes to watch, to a specific set of subscribers who have indicated an interest in receiving such information or loading a demo or an excerpt of the TV program for their review. The central real-time exchange 115 can provide real-time ranking info of content sellers so that subscribers can make instant decisions about their interest to buy or try content offered by the seller.

In accordance with the contemplated embodiments, continuous monitoring of vast numbers of digital content sources can be achieved with minimal effort and very low cost by indicating certain keywords or subjects to the central real-time exchange 115 or other collection programs. Notifications can be sent almost immediately to a variety of communication devices, such as wireless devices, PDA's, computers, etc. In accordance with the contemplated embodiments, the digital content can appear in a variety of formats and will be compatible with existing standards and proprietary systems, such as email, iTunes™, digital media players, instant messengers, Short Message Service (SMS) messages and Bloomberg terminals.

In addition, central real-time exchange 115 provides client software interface and personal web-logs which permit subscribers to manage their accounts, queries, budgets, profiles, historical events and prioritization that are stored in historical data database 527. Moreover, central real-time exchange 115 also synchronizes user storage devices with all relevant information that is found. As a result, the subscribers are continuously provided with the relevant content related to categories they care about most, and can access them immediately on their device without the need to access the network or use their computers. Preferably, the subscribers are provided with up to 60 days of the latest digital content which they may access locally without Internet connections, because the central real-time exchange synchronizes their content when it is available online.

Many websites do not allow crawlers or non-subscribers to access internal data. As a result, the majority of the digital content on the website is not accessible to search engines. In contrast, the central real-time exchange 115 of the contemplated system functions as a trusted partner in collecting, processing and notifying specific subscribers with specific digital content that otherwise would not be available. Here, the central real-time exchange 115 can also function as a clearing facility to process large numbers of transactions that require micro payments that would otherwise not be economical for any of the individual content owners, DRM license owner or content sellers to process. The central real-time exchange 115 can manage the login, security, and validation of subscriber information for millions of small owners of content or sellers of content who may not have a relationship with such clients but would like to charge for their service. In an embodiment, the central real-time exchange 115 manages and delivers advertising or competitive content on a content owner's original site when users or content buyers utilize notifications by the central real-time exchange to link or visit the actual website of the content owners.

In another embodiment, the flow of digital content is used to generate profits for the owners of content, DRM license owners, aggregators or traders of ad queries, subscribers and advertisers of the central real-time exchange 115. Here, the central real-time exchange provides for complete transparency of pricing related to any buy and sell offer for digital content or event triggered ads bundled with such digital content. Such transparency dramatically reduces the need for aggregators, such as Google™, Yahoo!™ and other search engines who use a system by which advertisers bid blindly to reach a user interested in digital content or licensing, without knowing what the market price is for such content or licensing. Such bids, which are subsequently translated into commercial listings provided side by side with the free search results generated by the search engines, provide a very high margin of accuracy and efficiency for the search engine. This is in stark contrast to users of the prior systems such as Google™ and Yahoo!™, where the owner of the content and the users of the search engine do not have a way of generating income or obtaining a portion of the fees charged by the search engine. In the environment of the said prior systems, the ability of the buyers of the content to refine their “hits” is limited, because the prior systems, such as Google™, Yahoo!™, have limited knowledge about the person performing the search or his real intent to buy or engage in commerce.

As one of the distinguishing features as compared to prior systems, the central real-time exchange 115 of the contemplated embodiments permits the content owners, DRM license owners, aggregators, subscribers and the content and license sellers to receive a portion of the fees charged by the central real-time exchange, as well as to obtain the true value of what content buyers and content sellers are willing to respectively pay or be paid for certain content, license or for performing specific transactions. Within this context, the central real-time exchange 115 charges a transaction fee as supposed to the margin between what it pays and what it collects from advertisers. Such full disclosure will immediately provide lower prices for advertisers and aggregate many users who will be happy to be paid for their daily queries. In another embodiment, the collection and sale of statistical and usage information about transactions conducted by the central real-time exchange provides another source of revenue. Many sources, which include financial institutions and brokers, will pay for such information since it can be used as an early indicator to show trends associated with digital content, licensings, companies, prices and services. Here, central real-time exchange 115 makes all such information available to third parties for a fee.

In accordance with the contemplated embodiments, an expanded list of categories in which subscribers have an interest is managed and proactive notification and formatting of such data is provided to content buyers 120 whenever a topic appears on the Internet in the context requested by the subscriber. As a result, advertisers and businesses selling digital content and licenses are permitted to target potential customers more accurately, while performing the customization of when and what to send to each subscriber. Different messages and different prices are also sent based on the specific events generated by third parties or the central real-time exchange 115. For example, the system of the contemplated embodiments permits an advertiser to indicate to the real-time exchange 115 that an ad about life insurance should be sent to all subscribers who have entered the word “disaster” only when news that contains digital content representing a disaster event passes through the central real-time exchange. Similarly, a manufacturer may request to send a specific ad with a specific price each time a news release or posting containing digital content representing a product from a competitor passes through the central real-time exchange. Here, the notice may be sent only to a specific set of subscribers which have provided a profile accepted by the manufacturer.

Central real-time exchange 115 also uses a combination of events to generate leads. For example, a person moving from one home to another will indicate to the central real-time exchange he is interested in receiving information pertaining to his new location. Here, a list is created of competitive offers from movers, mortgage banks, insurance agents, local merchants and other relevant things the subscriber may need but may not think of. The real-time exchange may also permit advertisers to target people who have completed a series of actions and select only those for a special promotion or for target marketing. The subscribers may request the real-time exchange to always provide competitive information for any offer made by an advertiser as a way to use the central real-time exchange to validate the value of a specific offer.

In accordance with an aspect of the contemplated embodiments, advertisers may embed complex tags, links, triggers and other forms of code to track the interaction of users with their offers sent by the central real-time exchange so they can match ads to actual orders for certain digital content on their systems and measure with a high degree of assurance their conversion rates and cost per new order or new customer. By linking such results from their supply chain and internal systems directly to the central real-time exchange 115, advertisers can automatically direct their budget away from groups and users who have low conversion rate to leads, notifications, events and triggers which have high conversion rates and reliably count on such data.

The contemplated embodiments represent only a small fraction of the uses central real-time exchange 115 may provide to businesses and individuals who need to be notified about events and changes occurring worldwide. For example, in other embodiments, the central real-time exchange 115 may also function as a third party web service clearinghouse to many other search engines and websites seeking to outsource the notification and management of their subscribers. As a result, an efficient and managed notification system is achieved, which simplifies and provides for a manageable individual portal of notifications and information. Such a system may be integrated with existing digital media players, email or IM programs to provide integrated messaging. Here, the central real-time exchange 115 can be used to provide free instant messaging for wireless devices by placing relevant ads or key word banners based in content sent from one wireless subscriber to another. As a result, the system of the contemplated embodiments replaces an SMS system, where the sender and receiver pay for each message that is sent over the system. Similarly, an instant messenger or any other program can link via web services or xhtml to central real-time exchange 115 and use it to serve ads or content to the buyers 120 or subscribers.

In another embodiment, central real-time exchange 115 may charge some content owners for their data, while paying other content owners for their data. For example, a company issuing a software release may have to pay for submitting its data to the central real-time exchange, while a newspaper writing about such a software release may be paid by the central real-time exchange for the submission of its data. Similarly, a subscriber to the central real-time exchange may pay to receive notifications from specific content sources, while being paid each time the notification from others is read. Here, the function of real-time exchange 115 is to collect, process, notify and settle the financial transactions resulting from each transaction triggered by the real-time exchange based on a pre-agreed financial formula entered by its members.

The matching performed by central real-time exchange 115 can be based on multiple algorithms all of which are trying to generate ever-improving matches and effective conversions per M hit (ECPM). The real-time exchange 115 attempts to find the optimum way to pay publishers the highest rate per click or banner while providing advertising a match to the site and specific page that will provide the best ECPM compared to all other options available on the web.

One algorithm of the central real-time exchange 115 ranks all advertisers into categories based on the type of digital content they provide, and then matches such categories with the historical average ECPM for a category from the history of transactions conducted on the system. Such a score is then used to dynamically manage placement of ads for any advertiser in that digital content within the category to ensure they obtain above average ECPM hits linked to the profile placed with the system.

This management system is segmenting all of the digital content and other media available spots into a select group that can achieve certain ECPM hits for each category. As the volume of transactions increases so does the effectiveness of such matching. Advertisers can lower their ECPM score if they need broader exposure or can't find sufficient sites to spend their budgets. On the content owner side, the content owners can see the ECPM results for each product category and modify their sites and their content to improve their ECPM ranking within the group, or either add or switch to other content categories, where they can obtain better monetization for their content. Since all such content is transparently available to both sides they can continuously adjust and improve this model to perfection.

The system of the contemplated embodiments is configured to charge for access to such digital content as part of its revenue sources. Owners of digital content and patent and trademarks owners are ranked by the system based on their ECPM in all categories resulting from historical transaction data. The system of the contemplated embodiments may recommend to the said owners the highest prices they can charge and show them where they would rank against all other intellectual property owners in the digital content, patent or trademark category. Furthermore, the system allows advertisers to see each individual intellectual property owner's site or banner or the entire listing and ranking in each category without any anonymity. However, the advertisers can also place automated orders to spend their budgets and allow the system to select which intellectual property owners to select. On the other hand, intellectual property owners can see the budgets and ECPM results of each category, but not the advertisers and their identity.

FIG. 5(b) is a plan view illustration of the central real-time exchange 115 in accordance with an embodiment of the invention. In particular, FIG. 5(b) shows the two (2) operating layers of the central real-time exchange 115. Ad trading layer 550 comprises business management layer 530, service management layer 531 and service delivery layer 552. The content buyers 120 and content sellers 125 and their respective ad servers 548 and 526, are members or subscribers to the central real-time exchange. The content buyers 120 and sellers 125 are connected to the ad trading layer 550 via the web trading interface 533 and the service delivery layer 552. Preferably, the web interface 533 is a website or web based application that allows the content buyers and content sellers to enter their orders, and to view the status of campaigns and all relevant financial and performance information relating to the same. Each layer 550 and 552 is connected to the data warehouse 534 that collects information relating to each and every transaction conducted by the content buyers and content sellers. The business management layer 530 of the ad trading layer 550 may comprise of: order management, matching of orders to prospective buyers, billing, settlement and reconciliation, rating and risk management, reporting, as well as financial accounting. The service management layer 531 functions comprise of the following: data collection, match plan generation, issue of orders to move media and/or digital content, track and report transactions, usage mediation, quality control, as well as trouble ticket handling. The service delivery layer 552 comprises: media and ad servers, intellectual property content being offered, certificate and authentication management, security and capacity management, as well as delivery and reporting to the respective networks and users of the marketplace.

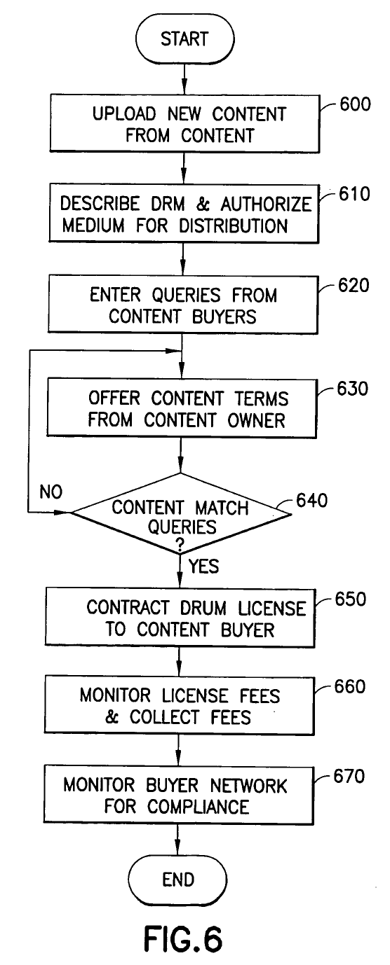

FIG. 6 is a flow chart illustrating the steps of the method in accordance with the contemplated embodiments. New content from content owners is uploaded to the central real-time exchange, as indicated in step 600. Next, the digital rights management (DRM) and the authorized medium for distribution of the uploaded digital content is defined, as indicated in 610.

Search queries from the content buyer are entered and stored in the system database, as indicated in step 620. In this case, the central real-time exchange 115 receives requests via other programs, brokers or aggregators or search engines in “wholesale” data feeds. The requests may be generated by an operating system, a specific application while a user operates a wireless device or a computer, or each time a search is performed using a browser or the Internet. The content buyers 120 may be asked if they wish to be notified about new content identified by such a search in the future. If the invitation is accepted, the query is combined with other information, such as stored advertisements, provided by his device, computer, web service, or the search engine used.

The combined information is translated into a complex query based on the user's profile, other previously entered user information and/or a ranking of search results. This new query is entered into the system database 110 (see FIG. 1) as a predetermined “static” query, which is accessed by central real-time exchange 115.

The central real-time exchange 115 continuously monitors the uploaded content to determine whether to offer license terms from content owners to content buyers, as indicated in step 630. Next, the central real-time exchange 115 compares every piece of uploaded content to a list of static queries entered by the content buyers to locate content in the uploaded data that matches the queries entered by the content buyers, as indicated in step 640. If no match is obtained, a return to step 630 occurs, where the central real-time exchange resumes monitoring the uploaded data to determine whether to offer license terms from content owners to content buyers.

If a match is obtained, the DRM license associated with the uploaded content is provided to the content buyer in accordance with the license terms offered from the content owners, as indicated in step 640. At this stage, the central real-time exchange 115 may attach advertising or promotional information provided by third parties based on the content buyer's query or the category sent to a profile of a subscriber. In addition, the central real-time exchange 115 may charge a fee to the subscribers and third parties for distributing content based on an agreed amount, a transaction fee or a dynamic market in which advertisers bid for the right to be included first in such notifications.

Next, the central real-time exchange continually monitors the license provided to the content buyer and collects the associated fees, as indicated in step 650. The matching content is then sent to the content buyer, along with the defined DRM and the authorized medium for distribution of the uploaded digital content, as indicated in step 660. The content is disseminated to the user or subscriber in a specific format and to a specific device, such as a computer, cell phone, PDA or some other web enabled device. Finally, the central real-time exchange 115 monitors the network to ensure DRM compliance in accordance with the license agreement, as indicated in step 670.

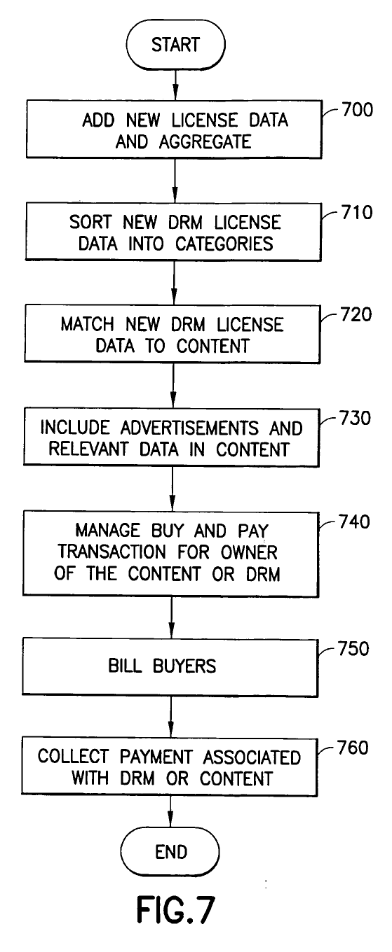

FIG. 7 is a flow chart illustrating steps of the method in accordance with an aspect of the contemplated embodiments of the invention. New DRM licenses are added to the exchange, as indicated in step 700. Once the new DRM licenses are added, they are aggregated and processed for temporary storage or indexing and stored permanently for future matching to each search and profile query entries made by subscribers of the central real-time exchange.

The aggregated DRM licenses are then sorted into content categories, such as type of movies or type of TV show, patents or trademarks, as indicated in step 710. Next, the DRM licenses are matched to digital content stored in the database of the system, as indicated in step 720. Next, advertisements and relevant data are included in or surrounding the digital content, as indicated in step 730.

Management of purchases is performed, as indicated in step 740. Here, the central real-time exchange 115 calculates the amount content buyers and advertisers need to pay and the amount due to any content owners or users based on pre agreed license terms, and then credits each user account.

Each content buyer is then billed, as indicated in step 750. The collection of payments associated with specific DRM licenses is then performed, as indicated in step 760. Here, billing and settlement database 220 (see FIG. 2) is used to perform all billing functions, such as charging, collecting and crediting the appropriate parties against their transactions.

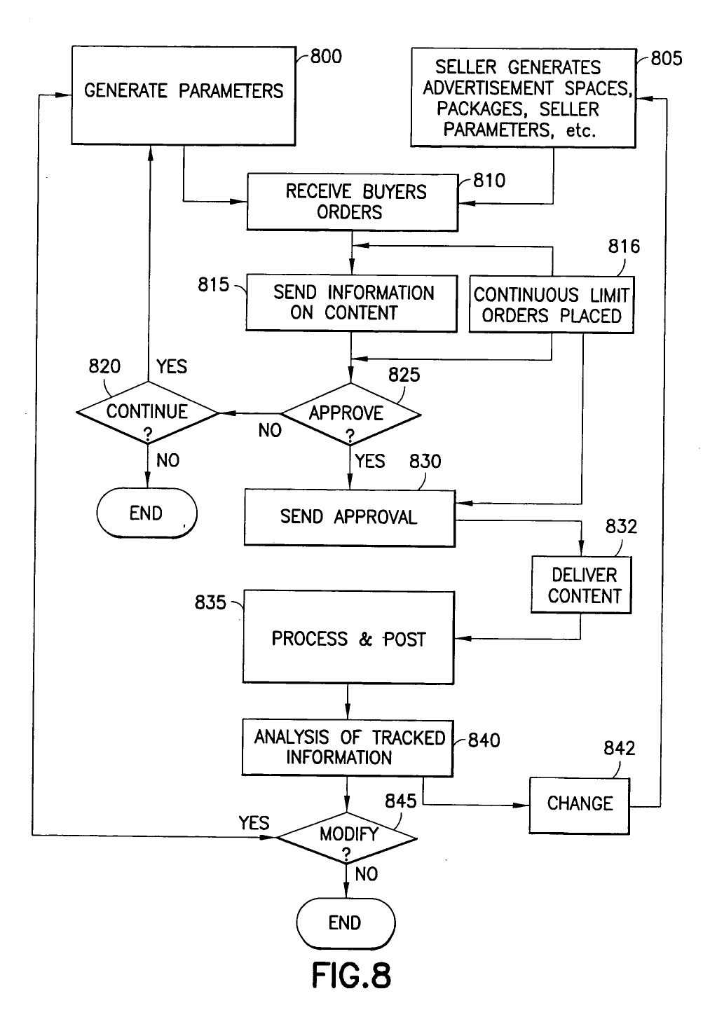

FIG. 8 is a flow chart illustrating the steps of the method in accordance with an embodiment of the invention. The owner of digital content generates all preliminary information about the desired content, as indicated in step 800. Here, the content owner 135 may set parameters, such as the required dollar amount to purchase the content, the compatible mediums, the minimum conversion numbers, the scope of the geographic coverage, the content owner's profile and historical data and the minimum prices to be paid for specific content. The content owner 135 also designates the parameters for use of the content, such as when, how and based on what events to increase or decrease purchase costs. In addition, content owner 135 modification of existing content following tracking information on the content is also performed, where the content owner 135 may view a dashboard (e.g., a graphical user interface—GUI) and supply chain information as well as pricing to make changes to purchase requirements. Further, the content owner 135 may also view offers for other mediums placed on the central real-time exchange and compare the proposed mediums. Here, the content owner 135 may place minimum purchase order bids with respect to the content offers.

Concurrently with the content owner generation of the preliminary information, the content seller generates advertisement spaces and prepares advertisement packages that may be purchased by buyers for single or multiple mediums he controls, as indicated in step 805. In an embodiment, the generation of the ad space and packages is performed using at least one of data from a dashboard database, seller licenses and a competitor's pricing that is based on information obtained from the central real-time exchange or a content buyer's prior behavior patterns. The content seller 125 can add or adjust his available license prices and availability up or down based on the balance of supply and demand in that specific segment of the advertising space for that specific time period.

Next, the information from both content owners 135 and content sellers 125 is sent to the central real-time exchange 115, as indicated in step 810. Upon receiving all of the information from both the buyers and the sellers, the central real-time exchange 115 performs a search to locate matches between content buyer orders and content seller offers. In certain embodiments, the content buyer's orders include bids. In addition, the central real-time exchange 115 processes information received from content buyers 120 and content sellers 125 regarding the parameters for buyer orders and seller offers. Buyers and sellers are permitted to view each other's actual listed prices, the actual prices listed by the system, as well as third party conversion information related to each buyer. As a result, the content owner and sellers are permitted to match their content to content buyers and sellers that will best utilize the ability to view the actual listed prices of the other content buyers and content sellers, as well as the actual prices listed by the system. In certain embodiments, content sellers may list their names and their licenses so that buyers can sample the available content. Alternatively, content owners may also list their names associated with just their content.

Next, the central real-time exchange 115 sends information on content matches to the content buyer for approval, as indicated in step 815. The content buyer 120 then decides whether to approve the sent match, as indicated in step 825. If the buyer does not approve at least one match that is presented by the central real-time exchange 115, the buyer determines whether to continue with the process, as indicated in step 820. Here, content buyers 120 may place continuous limit orders with the central real-time exchange. Such orders are instructions for the central real-time exchange to maintain and place ads in content at different locations with sellers whose performance exceeds the minimum requirement set by the content owner buyer. For example, a buyer may place an order to buy $100,000 of US web advertising with a maximum $4 cost-per-click (CPC), a $1 cost-per-thousand (CPM) and a $25 (CPA) for jewelry listings. The central real-time exchange then monitors all cost-per-click ads available, and their pricing information, while attempting to match said ads to the appropriate digital content within the budget provided by the buyer until the buyer's budget is spent. In the preferred embodiment, the central real-time exchange uses the Basian theory of prediction of ad value and then perform ad placement based on the same.

On the other hand, if the buyer approves at least one match that is presented by the central real-time exchange, then the content buyer sends his approval to the exchange, as indicated in step 830. Next, the central real-time exchange processes the content buyer's approval and instructs the database to post the selected digital content at the selected times, indicated in steps 832 and 835. At this point, the advertising exchange 300 (see FIG. 3) collects transaction information from the applicable web or media servers, and other third party tracking agencies. The advertising exchange 300 then tracks and rates the performance of the posted advertisements and reports such information to the central real-time exchange 115, pricing database 110a (see FIG. 2) and to other parts of the system. As a result, other buyers and transactions can be changed if necessary, based on the results generated by the applicable medium.

Next, the information obtained from the tracking agencies are analyzed, as indicated in step 840. Here, the central real-time exchange 115 may determine that a particular digital content is more effective for diamond sales and not shoes and thus, perform a real-time exchange of digital content that is delivered with specific advertising. In accordance with an embodiment, the central real-time exchange then sends the resultant tracking information to the content owner primarily to perform the analysis. Upon receiving resultant tracking information, the content owner decides whether to add new content or modify the parameters, as indicated in step 845. If the content owner 135 decides not to add content or modify the parameters, the method is terminated. However, if the buyer decides to add a new content or to modify existing parameters, then a return to step 800 occurs, where the content owner is permitted to generate new information, provide new parameters for new content or perform modifications to an existing parameters.

Also at this point, the content seller can decide to change the pricing or availability of any particular content, as indicated in step 842. At which point, the process reverts back to step 805 where the seller generates the available spaces, packages, etc to the central real-time exchange.

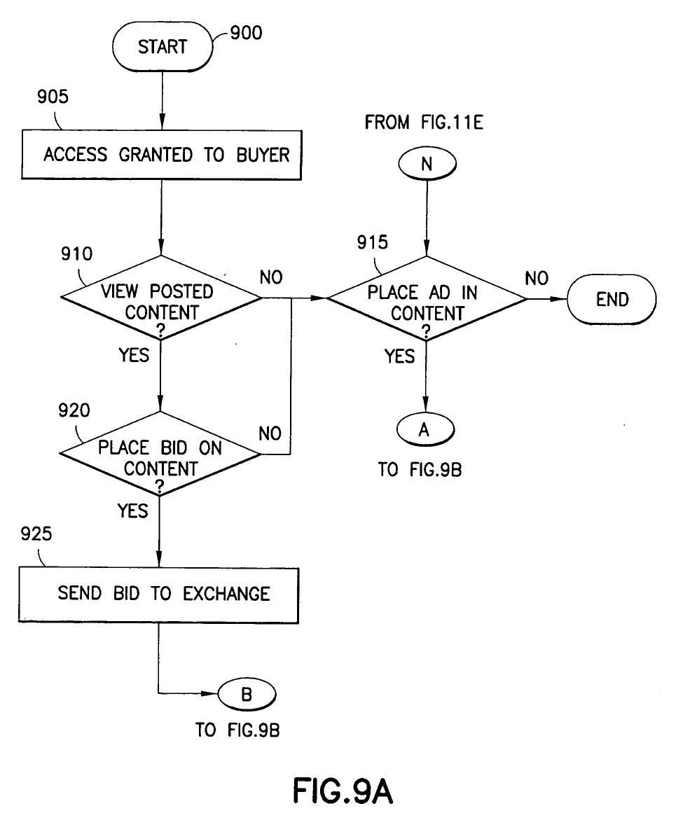

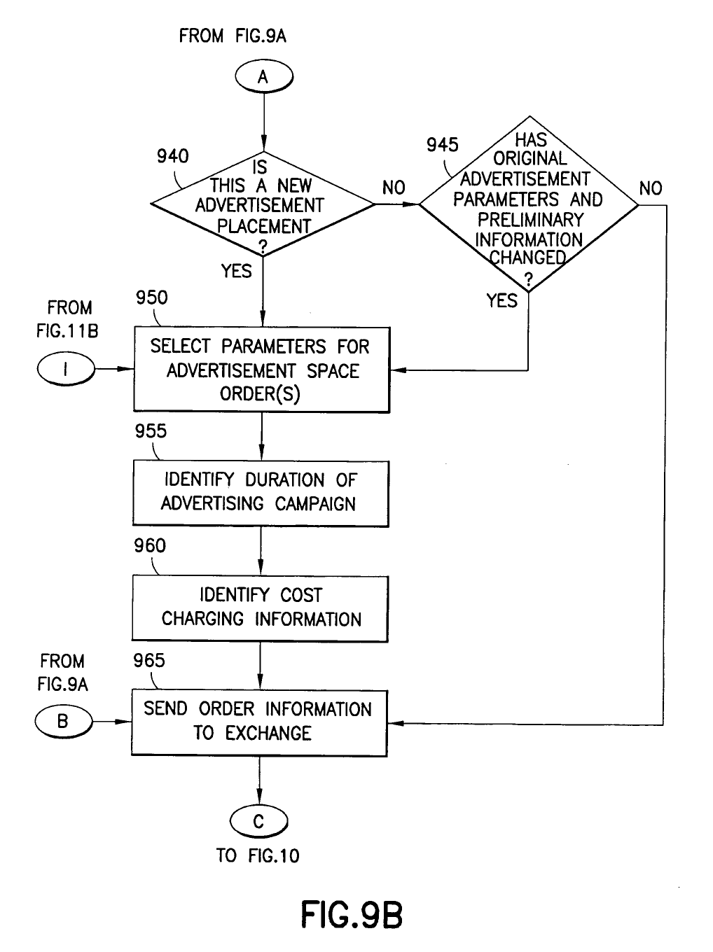

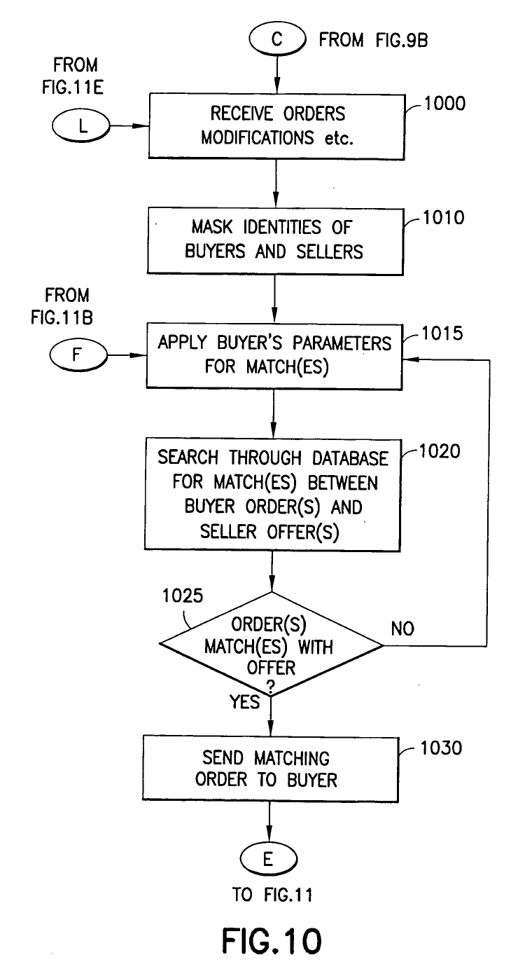

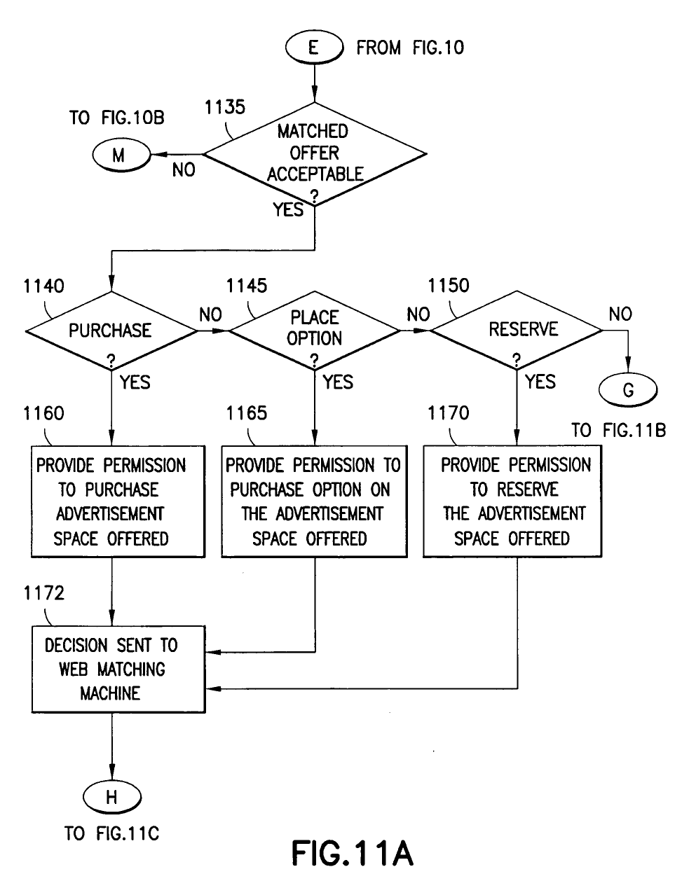

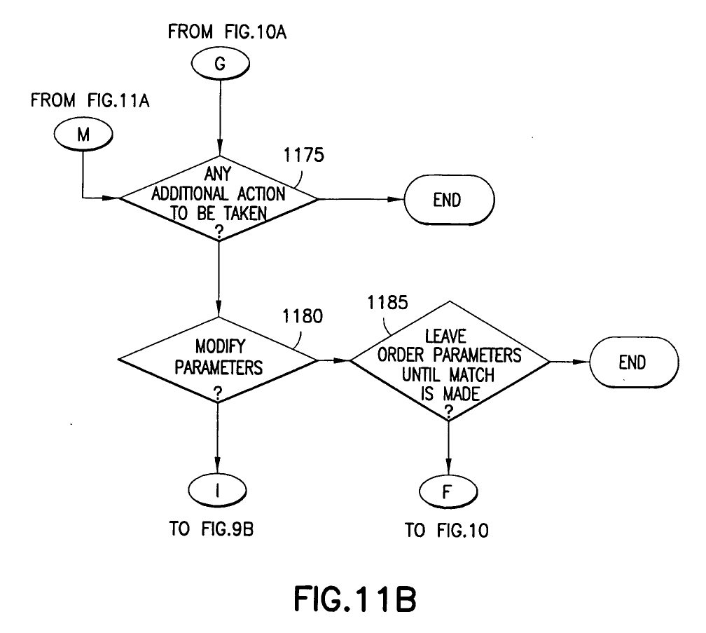

FIGS. 9(a) and 9(b) is a flow chart illustrating the steps associated with the activities of a buyer up to the transmittal of content from the content owner to the central real-time exchange 115 of FIG. 2. The content buyer 120 is granted access to the central real-time exchange 115, as indicated in step 905. The content buyer then determines whether he wishes to view posted content offers, as indicated in step 910. If the buyer wishes to view the content offers, the buyer then determines whether to place a bid on any offer deemed desirable, as indicated in step 920. If the content buyer chooses to place a bid, the buyers then sends a bid or bids on the content to the central real-time exchange for subsequent use in accordance with the method of the contemplated embodiment, as indicated in step 925.

If, on the other hand, the buyer does not want to view or bid on previously posted content offers, they determine whether to place an order for advertisement space on the digital content, as indicated in step 915. Here, a check is performed to determine whether the DRM associated with the content permits a combination of a particular ad with the specific digital content. If the content buyer does not want to place an order, then the method is terminated. If, however, the buyer does want to place an order, they determine whether the advertisement placement is new, as indicated in step 940. If the advertisement placement is new, the buyer is presented with the option to select parameters for the advertisement space orders, as indicate in step 950. If, on the other hand, the advertisement placement is not new, then the buyer determines whether the parameters of the existing advertisement and preliminary information have changed, as indicated in step 945. If a change in the parameters of the existing advertisement and preliminary information has occurred, then a return to step 950 occurs, where the buyer is presented with the option to select parameters for the advertisement space orders. If, however, a change in the existing advertisement and preliminary information has not occurred, then the buyer is presented with the option to re-send the advertisement space, parameters, campaign duration, cost changing information and other preliminary information to the central real-time exchange, as indicated in step 965.

After selecting parameters for the advertisement space orders in step 950, the buyer identifies the duration of the advertising campaign, as indicated in step 955. Next, the buyer identifies the cost charging information, as indicated in step 960. Information is then sent to the central real-time exchange, along with other advertisement space, parameters, campaign duration and cost charging information for subsequent use, as indicated in step 965.

FIG. 10 is a flow chart illustrating the steps associated with receiving, processing and matching content buyer orders and content seller offers at the central real-time exchange 115 in accordance with the contemplated embodiments. Initially, the central real-time exchange receives the content orders from the buyers and advertisement placement offers from the sellers, as indicated in step 1000. At this point, the central real-time exchange also receives modifications to existing orders or offers and receives other information from both buyers and sellers.

Next, the central real-time exchange masks the identities of all participant buyers and sellers, as indicated in step 1010. The central real-time exchange then applies the buyer's parameters for matches with seller offers, as indicated in step 1015. Pursuant to applying the buyer's parameters, the central real-time exchange searches through the database for matches between buyer orders and seller offers, as indicated in step 1020. Next, the central real-time exchange determines whether an order matches with an offer, as indicated in step 1025. If a matching order is not located, then a return to step 1015 occurs, where the central real-time exchange once again applies the content buyer's parameters to locate a match. If a match is located, then the central real-time exchange sends the matching offers to the particular buyer for use in accordance with the method of the invention, as indicated in step 1030.

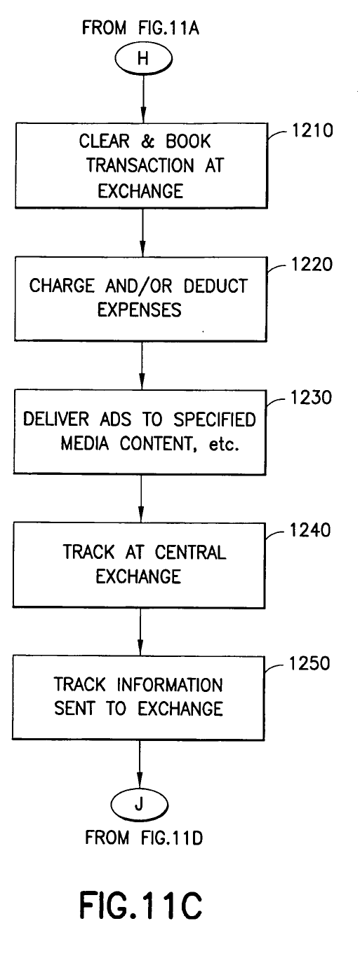

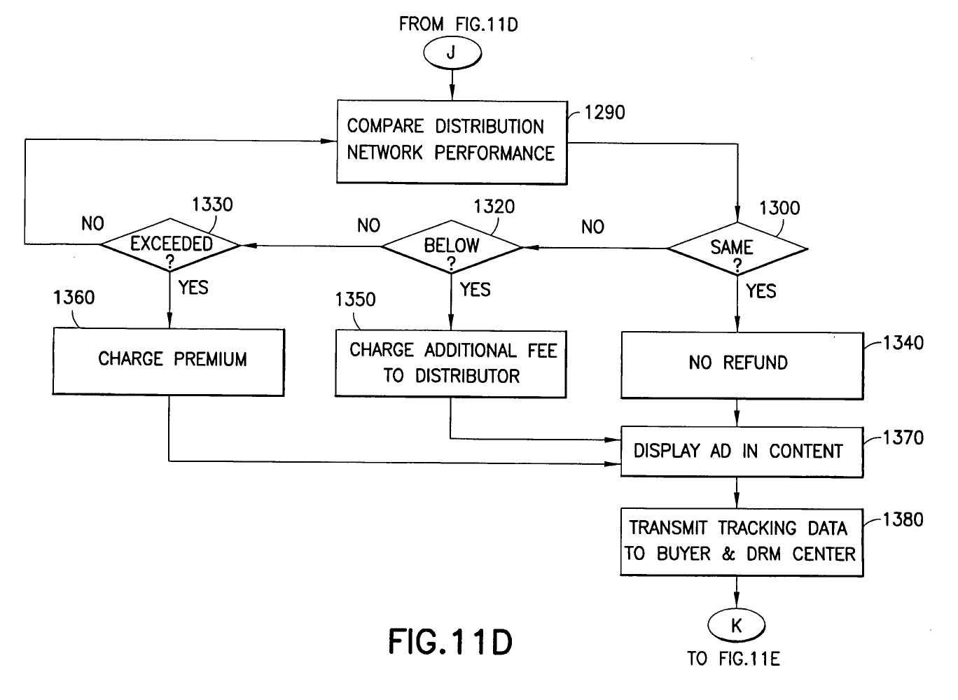

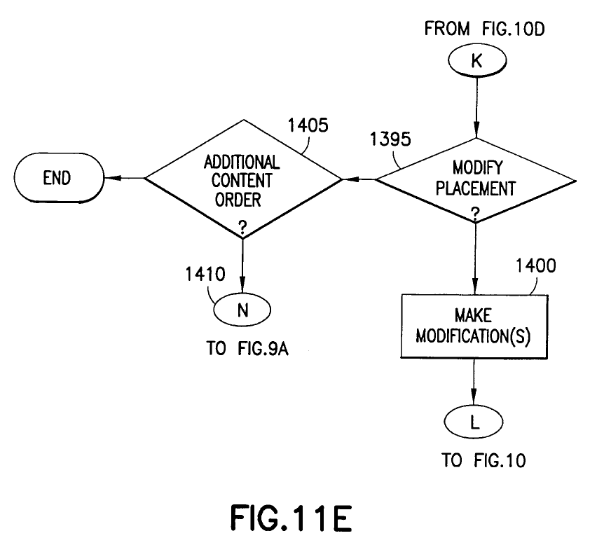

FIGS. 11(a) thru 11(e) is a flow chart illustrating the steps associated with the decision-making that is performed by the content buyer after the central real-time exchange has located at least one match between the order from the content buyer and at least one offer from the seller. The buyer views the order to determine whether the matching offer is acceptable, as indicated in step 1135. As illustrated in FIG. 11(b), when an offer is unacceptable, the buyer determines whether any additional actions should be taken, as indicated in step 1175. If an additional action is not required, the method is terminated. However, if additional action is required, then the buyer determines whether to modify the existing parameters of an existing advertisement, as indicated in step 1180. If the buyer elects to make modifications in the parameters associated with the existing advertisement space, a return to step 950 of FIG. 9(b) occurs. However, if the buyer does not elect to modify the parameters associated with the existing advertisement space, the buyer then determines whether to leave the existing order parameters until a match is made, as indicated in step 1185. If the buyer elects not to leave the order parameters until a match is made, the method is terminated. On the other hand, if the buyer elects to leave the order parameters until a match is made, a return to step 1015 of FIG. 10 occurs.

With reference to FIG. 11(a), if the buyer determines that the match is acceptable at step 1135, they then determine whether to purchase the offered content, as indicated at step 1140. However, if the buyer elects not to purchase advertisement space, then the buyer determines whether to place an option on the offered advertisement space within the content, as indicated in step 1145. Here, as before, if the buyer elects not to place an option on the offered advertisement space within the content, the buyer then determines whether to reserve the offered advertisement space, as indicated in step 1150. If the buyer determines that he does not want to reserve or place an option on the advertisement space or purchase the offered advertisement space, then a return to step 1175 of FIG. 11(b) occurs. However, in the case where the buyer elects to either purchase the offered advertisement space or place an option on the offered advertisement space or reserve the offered advertisement space, the method proceeds to one of steps 1160, 1165 and 1170, respectively. Here, the buyer is provided with permission to either purchase a placement option or reserve the advertisement space that is offered for purchase. The decision of the buyer is then sent to the central real-time exchange, as indicated in step 1172.

Referring to FIG. 11(c), the central real-time exchange 115 then clears and books the transaction, as indicated in step 1210. The central real-time exchange then charges and deducts, where applicable, associated expenses with booking the transaction, as indicated in step 1220. Next, the central real-time exchange delivers advertisements to specified media, along with the content and relevant DRM license, as indicated in step 1230. Tracking information is then obtained by the central real-time exchange 115 to monitor the performance of the posted advertisements, as indicated in step 1240. Next, the tracking information is analyzed by the central real-time exchange 115, as indicated in step 1250.

Referring to FIG. 11(d), the central real-time exchange 115 then compares the actual dollar level commitment of the distribution network with a promised level of performance to the content owner, as indicated in step 1290. The central real-time exchange 115 then determines whether the distribution network performance matches the promised level of performance to the content owner, as indicated in step 1300. If the distribution network's level of performance matches the promised level of performance, then the central real-time exchange does not pay a refund to the buyer, as indicated in step 1340. However, if the distribution network performance is not the same as the promised level of performance to the content owner, then the central real-time exchange determines whether the distribution network level of performance was below the promised level of performance, as indicated in step 1320. If the advertisement space level of performance was below the promised level of performance, then the central real-time exchange issues an additional charge against the distribution network, as indicated at step 1350. If the level of performance was not below the promised level of performance, the central real-time exchange determines whether the level of performance exceeded the promised level of performance, as indicated in step 1330. If the performance level of the distribution network exceeded the promised level of performance, then the central real-time exchange charges the buyer a premium price, as indicated in step 1360. If the performance level of the distribution network does not exceed the promise level of performance, then a return to step 1290 occurs.

Subsequent to steps 1340, 1350 and 1360, where the central real-time exchange either charges, refunds or does not provide a buyer with a refund or other compensation, the central real-time exchange displays tracking data related to the placed advertisement in the digital content, as indicated in step 1370. Next, the central real-time exchange transmits the tracking data to the buyer and the DRM license owner for review, as indicated in step 1380.

With reference to FIG. 11(e), after receiving tracking data, the buyer decides whether to modify an existing placement, as indicated in step 1395. If the buyer decides to modify an existing ad placement, then modifications are performed, as indicated in step 1400, and a return to step 1000 of FIG. 10 occurs. If, however, the buyer decides not to modify an existing ad placement, the buyer then determines whether to add an additional order for content, as indicated in step 1405. If the buyer decides not to add additional content, then the method is terminated. On the other hand, if the buyer decides to add an additional order for content, a return to step 915 of FIG. 9(a) occurs, as indicated in step 1410.

In certain embodiments, options such as pop up ads, streaming video, banners, key words, ads, billboards, radio, TV and DVD ads, are implemented. Here, the options are tracked via specific promotion codes or digital xml or html links, as well as via web services. In accordance with the contemplated embodiments, it is contemplated that as more and more devices become wireless, it will be advantageous to configure these devices such that they may report interaction with users based on Bluetooth, radio frequency identification (RFID) or some other type of discovery between the users and ads.

In alternative embodiments, a browser plug-in is used to provide a browser with the ability to disclose user information to a trusted (i.e., secure) central real-time exchange to better match the user's needs or search results. In accordance with the present contemplated embodiment, the central real-time exchange utilizes the user information to provide an optimal ranking of the content sellers and to provide an optimal match between the content buyers and content sellers. Here, the real-time exchange may use third party consumer profiling companies such as Acxiom to allow extremely targeted marketing by combining personal and profiling information to produce optimized results for content buyers. Moreover, content sellers may trust the disclosure of their personal and confidential information to the central real-time exchange, because the disclosed information is only used as an aggregate to improve the overall performance of the facility for all users.

The system and method of the contemplated embodiments permits the creation of a marketplace for the transfer and distribution of digital content, and provides real-time market pricing for different sources of content and the price that different entities are willing to pay to tag, attach or advertise in or around such information. In addition, subscribers and publishers may use the information to sell content based on a pre-agreed price, while other subscribers may let the central real-time exchange automate and optimize their income based on current market prices.

Furthermore, the contemplated embodiments of the systems and method permit the rapid exchange of digital content, such as music, video games or files, movies, images, audio files, DRM rights or software. Transfers are permitted from an individual to another individual or from one individual to multiple individuals. The central real-time exchange continuously monitors and authorizes rights, while scanning the Internet for license violations or piracy by examining different content files and comparing them to items in the database. In addition, multiple third party DRM locations and multiple financial institutions as well as distribution partners are supported by the system and method of the invention. The price for digital content is determined by agreement or auction. The system and method of the invention create a marketplace for individuals or large entities to trade ownership of DRM and existing licensing contracts.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

1. A method for managing distribution and usage of digital content over a network; comprising:
receiving uploaded new content from content owners to a central real-time exchange of a system;
defining at least one of digital rights management and an authorized medium for distribution of the uploaded digital content;
entering and storing search queries from content buyers in a database of the central real-time exchange;
continuously monitoring, at the central real-time exchange, the uploaded content to determine whether to offer license terms from content owners to content buyers;
comparing, at the central real-time exchange, the uploaded content to a predetermined list of queries entered by the content buyers to locate content in the uploaded data that matches queries entered by the content buyers;
continuing to monitor, at the central real-time exchange, the uploaded content to determine whether to offer license terms from the content owners to the content buyers if no matched queries are obtained;
providing a digital rights management license associated with the uploaded content to a content buyer in accordance with the license terms offered from the content owners if a matching query is obtained;
continually monitoring, at the central real-time exchange, the digital rights management license provided to the content buyer and collecting associated fees;
sending the matching content, the defined digital rights management and the defined authorized medium to the content buyer for distribution of the uploaded digital content; and
monitoring, at the central real-time exchange, the network to ensure digital rights management compliance in accordance with the license agreement.

2. The method of claim 1, wherein the central real-time exchange receives requests via at least one of other programs, brokers or aggregators and search engines in “wholesale” data feeds.

3. The method of claim 2, wherein the requests are generated by at least one of an operating system, a specific application while a user operates a wireless device or a computer and each time a search is performed using a browser or the Internet.

4. The method of claim 3, wherein the content buyers are queried to determine whether they wish to be notified about new content identified by future searches.

5. The method of claim 4, wherein if an invitation for notification about new content is accepted, the query is combined with other information

6. The method of claim 5, wherein the other information comprises one of stored advertisements or a search engine used

7. The method of claim 5, wherein the combined information is translated into a query based on at least one of a user's profile, other previously entered user information and a ranking of search results

8. The method of claim 7, wherein the combined information comprises a new query that is entered into the database as the predetermined query which is accessed by the central real-time exchange

9. The method of claim 1, further comprising:
attaching, at the central real-time exchange, one of advertising or promotional information provided by third parties based on a query or a category sent to a profile of a subscriber by the content buyers.

10. The method of claim 9, further comprising:
charging, at the central real-time exchange, a fee to at least one of the subscribers and third parties for distributing content based on one of an agreed amount and a transaction fee

11. The method of claim 1, wherein the content is disseminated to one of a user or subscriber in a specific format and to a specific device

12. The method of claim 11, wherein the specific device comprises one of a computer, cell phone, PDA and web enabled device.

13. The method of claim 1, further comprising:
adding new digital right management licenses to the central real-time exchange.

14. A system for managing distribution and usage of digital content over a network; comprising:
a search engine configured to correlate owners of digital rights management related to the digital content; and
a central real-time exchange operatively interfaced with the search engine, said central real-time exchange including a database and a plurality of modules for at least one of indicating pricing, searching, title indexing, digital contract management, fingerprinting and watermarking digital content that is uploaded to the database.

15. The system of claim 14, wherein the central real-time exchange is configured to permit third party fulfillment houses of digital content to sign up to perform delivery and distribution for the content owners on behalf of the central real-time exchange to provide digital content to a single user or multiple purchasers of the content.

16. The system of claim 15, wherein the fulfillment houses of digital content comprise at least one of retail stores, music distributors or DVD suppliers.

17. The system of claim 14, wherein the central real-time exchange is configured to permit software companies to outsource management of software distribution and license management.

18. The system of claim 14, wherein the central real-time exchange further comprises a program information identifier and audit module for inserting and comparing tags and codes.

19. The system of claim 19, wherein the codes comprise at least one of watermarks, special tags or ID's, scanning of files, audio sampling and character recognition.

20. The system of claim 19, wherein the tags and codes are inserted and compared with corresponding information for the digital content that is located in the database to verify what source and under which digital rights management license the content is being provided.

21. The system of claim 14, wherein the system is configured to match digital content with at least one of advertisers, broadcasters and networks providers.

22. The system of claim 14, wherein the information comprises at least one of names of authors, directors, actors, games, movies, images, software and audio files.
